(19) United States
(12) Patent Application Publication
(10) Pub. No.: US 2014/0328194 A1
(43) Pub. Date: Nov. 6, 2014

(54) METHOD AND SYSTEM FOR HANDLING INTERFERENCE BETWEEN A LOW POWER NETWORK AND A HIGH POWER NETWORK SHARING A COMMON FREQUENCY BAND

(71) Applicant: SAMSUNG ELECTRONICS CO., LTD., SUWON-SI (KR)

(72) Inventors: Debarati SEN, Bangalore (IN); Ranjeet Kumar PATRO, Bangalore (IN); Chandrashekhar Thejaswi P.S., Bangalore (IN)

(73) Assignee: SAMSUNG ELECTRONICS CO., LTD., SUWON-SI (KR)

(21) Appl. No.: 14/265,836

(22) Filed: Apr. 30, 2014

(30) Foreign Application Priority Data
May 2, 2013 (IN) 1965/CHE/2013

(51) Int. Cl. H04W 72/08; H04W 24/08

(52) U.S. Cl. CPC H04W 72/082; H04W 24/08
USPC 370/252; 370/329

(57) ABSTRACT

A method and a system for handling interference between a low power network and a high power network sharing a common frequency band are provided. The method includes receiving an association request message containing a set of parameters from the low power device. The method further includes determining a second set of parameters for transmission of the data in the uplink direction based on the first set of parameters, where the second set of parameters indicates resources allocated to the low power device for transmitting the data in a presence of interference from the high power network device on the common frequency band. Moreover, the method includes sending an association response message containing the second set of parameters to the low power device in response to the association request message.

### CROSS-REFERENCE TO RELATED APPLICATION(S)

The application claims the benefit under 35 U.S.C. §119(a) of an Indian patent application filed on May 2, 2013 in the Indian Patent Office and assigned Serial number 1965/CHE/2013, the entire disclosure of which is hereby incorporated by reference.

### TECHNICAL FIELD

The present disclosure relates to the field of wireless communication systems. More particularly, the present disclosure relates to a method and system for handling interference between a low power network and a high power network sharing a common frequency band.

### BACKGROUND

An Ultra-Low Power (ULP) sensor network refers to a wireless personal area network that includes sensor nodes having sensors for detecting and collecting specific information and an access point for transmitting collected information to an external network. Typically, the ULP sensor network operates with a transmit power of 1 mW (0 dBm). In an ULP sensor network, data signals or control signals are desired to be exchanged between the sensor nodes and the access point on the 2.4 GHz Industrial, Scientific and Medical (ISM) band. The ISM bands are radio bands reserved internationally for use of Radio Frequency (RF) energy for industrial, scientific and medical purposes other than communications.

Around 83.5 MHz bandwidth in the 2.4 GHz ISM band is occupied by the Wi-Fi network (e.g., 802.11b/g/n), BlueTooth (BT), Zigbee, Microwave ovens, Institute of Electrical and Electronics Engineers (IEEE) 802.15.4 and IEEE 802.15.6 based devices. For example, in the 83.5 MHz bandwidth, each Wi-Fi Access Point (AP) occupies a 22 MHz bandwidth. Thus, when three Wi-Fi APs are operating in a close environment, the 83.5 MHz bandwidth is almost completely occupied. The full 83.5 MHz bandwidth is occupied when BT and Zigbee devices operate simultaneously with WiFi. In such a scenario, the ULP sensors may not find an interference free channel in the 83.5 MHz bandwidth for data transmission/reception to/from a ULP AP. However, if the ULP sensor network communicates simultaneously with the Wi-Fi network and Bluetooth network over the 83.5 MHz bandwidth, the ULP sensor network may suffer critically from high interference from the Wi-Fi network and the BT network since transmit power (0 dBm) of the ULP sensors is 100 times less than transmit power (e.g., 20 dBm) of the Wi-Fi and Bluetooth class 1 devices. Interference caused by the Wi-Fi devices can vary over frequency, time and distance between the Wi-Fi devices and the ULP sensors. Sometimes, the interference may be so high that it can remain constant over several minutes to hours, thereby continuously interfering with ULP communication over a long period of time.

Currently, a number of solutions have been suggested for combating interference between Bluetooth and Wi-Fi devices as well as Zigbee and Wi-Fi devices on the 2.4 GHz band. For example, Bluetooth devices adopt an Adaptive Frequency Hopping (AFH) scheme to avoid interference from the Wi-Fi devices. In the AFH scheme, the Bluetooth devices hop over multiple radio channels to find a Wi-Fi interference free channel and transmit data signals over multiple hopped channels. Zigbee devices transmit at a higher data rate and transmit on non-overlapping 2 MHz channels in the presence of Wi-Fi transmission. However, the current solutions do not provide scalability in handling varying interference patterns from the Wi-Fi devices on the 2.4 GHz band.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and system for handling interference between a low power network and a high power network sharing a common frequency band.

In accordance with an aspect of the present disclosure, a method of handling interference between a low power network device and a high power network device during communication on a common frequency band, is provided. The method includes receiving an association request message at the access point from the low power network device, wherein the association request message comprises a first set of parameters (data rate requirements, Quality of Services (QoS) requirements and processing power) associated with data to be transmitted in an uplink direction and determining a second set of parameters (admissible data rate, channel information associated with the allocated channels and code information) for transmission of the data in the uplink direction based on the first set of parameters wherein the second set of parameters indicates resources allocated to the low power device for transmitting the data on a common frequency band in a presence of interference from the high power network device on the common frequency band. Then the access point sends an association response message containing the second set of parameters to the low power device in response to the association request message.

In accordance with another aspect of the present disclosure, an apparatus for handling interference between a low power network device and a high power network device during communication on a common frequency band, is provided. The apparatus includes a transceiver and a processor. The processor is coupled to the transceiver, wherein the transceiver is configured to receive an association request message comprising a first set of parameters associated with data to be transmitted in uplink direction from the low power network device, and wherein the processor is configured to determine a second set of parameters for transmission of the data in the uplink direction based on the first set of parameters, where the second set of parameters indicates resources allocated to the low power device for transmitting the data on a common frequency band in presence of interference from the high power network device on the common frequency band, and wherein the transceiver is configured to send an association response message containing the second set of parameters to the low power device in response to the association request message.

In accordance with yet another aspect of the present disclosure, a method of communicating control signals with low power device in a downlink direction, is provided. The method includes identifying a first group of contiguous at least one of interference free and low interference channels from a plurality of channels in a frequency band based on a pre-defined category of the plurality of channels, identifying a second group of at least one of interference free and low interference channels from a remaining of the plurality of channels based on the pre-defined category of the remaining channels, transmitting a primary control signal on the second group of the at least one of interference free and low interference channels, wherein the primary control signal indicates channel information associated with the first group of the contiguous at least one of the interference free and low interference channels, and transmitting a main control signal following the primary control signal on the group of the contiguous at least one of the interference free and low interference channels, wherein the main control signal comprises control data.

In accordance with still another aspect of the present disclosure, an apparatus for communicating control signals with low power device in a downlink direction, is provided. The apparatus includes a transceiver and a processor. The processor is coupled to the transceiver, wherein the processor is configured to identifying a first group of contiguous at least one of interference free and low interference channels from a plurality of channels in a frequency band based on a pre-defined category of the plurality of channels, and wherein the processor is configured to identifying a second group of at least one of interference free and low interference channels from a remaining of the plurality of channels based on the pre-defined category of the remaining channels, and wherein the transceiver is configured to transmit a primary control signal on the second group of the at last one of interference free and low interference channels, where the primary control signal indicates channel information associated with the first group of the contiguous at least one of the interference free and low interference channels, and wherein the transceiver is configured to transmit a main control signal following the primary control signal on the first group of the contiguous at least one of the interference free and low interference channels, where the main control signal comprises control data.

In accordance with yet another aspect of the present disclosure, a method of handling interference between a low power network and a high power network, is provided. The method includes sending an association request message to an access point, receiving an association response message from the access point in response to the association request message, wherein the association response message comprises an admissible data rate, channel information of allocated channels, code information of allocated codes, and a signal processing information, generating a data signal based on the channel information and the code information, and transmitting the data signal to the access point on the allocated channels according to the admissible data rate.

In accordance with still another aspect of the present disclosure, an apparatus for handling interference between a low power network and a high power network, is provided. The apparatus includes a transceiver and a processor. The processor is coupled to the transceiver, wherein the transceiver is configured to send an association request message to an access point, wherein the transceiver is configured to receive an association response message from the access point in response to the association request message, where the association response message comprises an admissible data rate, channel information of allocated channels, code information of allocated codes, and a signal processing information, and wherein the processor is configured to generate a data signal based on the channel information and the code information, and wherein the transceiver is configured to transmit the data signal to the access point on the allocated channels according to the admissible data rate.

In accordance with yet another aspect of the present disclosure, a transmitter is provided. The transmitter includes a spreader configured to spread data on each of one or more channels using a unique spreading code to obtain a spread data signal, a sampling rate converter configured for sampling the spread data signal at a sampling rate, an up converter configured to convert the spread data signal to a radio frequency signal, and a Radio Frequency (RF) unit. The RF unit is configured to process the RF signal based on at least one signal processing scheme to mitigate interference on the one or more channels of a frequency band from high power network device, and transmit the processed RF signal on the one or more channels.

In accordance with still another aspect of the present disclosure, a receiver is provided. The receiver includes an RF unit configured to process a RF signal received from a transmitter on one or more channels of a frequency band, a band pass filter configured to filter the processed RF signal, an analog to digital converter configured to convert the analog RF signal into a digital signal, and a baseband processor configured to process the digital signal to detect data corresponding to an original signal.

In accordance with yet another aspect of the present disclosure, a system is provided. The system includes at least one low power device configured to send an association request message, wherein the association request message comprises a first set of parameters associated with data to be transmitted in uplink direction, and an access point. The access point is configured to determine a second set of parameters for transmission of the data in the uplink direction based on the first set of parameters, wherein the second set of parameters indicates resources allocated to the low power device for transmitting the data on a common frequency band in presence of interference from high power network device on the common frequency band, and send an association response message containing the second set of parameters to the low power device in response to the association request message.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a block diagram of a Wireless Personal Area Network (WPAN) system according to an embodiment of the present disclosure.

FIG. 1B is a schematic representation of a band plan for a WPAN system, according to an embodiment of the present disclosure.

FIG. 2 is a flow diagram illustrating a method of allocating resources to low power devices for data transmission in an uplink direction according to an embodiment of the present disclosure.

FIG. 3 is a process flowchart illustrating a method of categorizing channels in a 83.5 MHz band based on interference from high power network devices according to an embodiment of the present disclosure.

FIG. 4 is a flow diagram illustrating a method of communicating data signal in uplink direction according to an embodiment of the present disclosure.

FIG. 5 is a process flowchart illustrating a method of re-allocation of resources based on a Signal to Interference Noise Ratio (SINR) associated with a data packet received from a low power device according to an embodiment of the present disclosure.

FIG. 6A is a schematic representation depicting a format of an association request message according to an embodiment of the present disclosure.

FIG. 6B is a schematic representation depicting a format of an association response message according to an embodiment of the present disclosure.

FIG. 7 is a flow diagram illustrating a method of communicating control signals with low power devices in a downlink direction according to an embodiment of the present disclosure.

FIG. 8 is a schematic representation depicting a format of a primary control signal according to an embodiment of the present disclosure.

FIG. 9 is a block diagram of an access point showing various components according to an embodiment of the present disclosure.

FIG. 10 is a block diagram of a low power device showing various components according to an embodiment of the present disclosure.

FIG. 11 illustrates a block diagram of a transmitter according to an embodiment of the present disclosure.

FIG. 12 illustrates a block diagram of a receiver according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure provides a method and system for handling interference between a low power network and a high power network sharing a common frequency band. In the following detailed description of the various embodiments of the present disclosure, reference is made to the accompanying drawings that form a part hereof, and in which are shown by way of illustration specific various embodiments in which the present disclosure may be practiced. These various embodiments are described in sufficient detail to enable those skilled in the art to practice the present disclosure, and it is to be understood that other various embodiments may be utilized and that changes may be made without departing from the scope of the present disclosure. The following detailed description is, therefore, not to be taken in a limiting sense, and the scope of the present disclosure is defined by the appended claims.

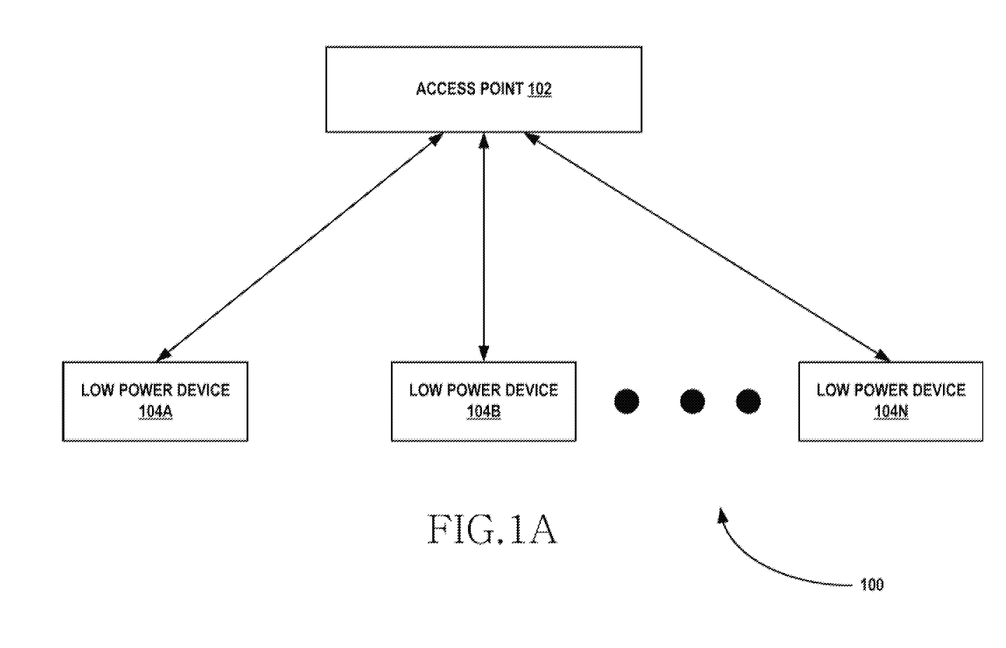

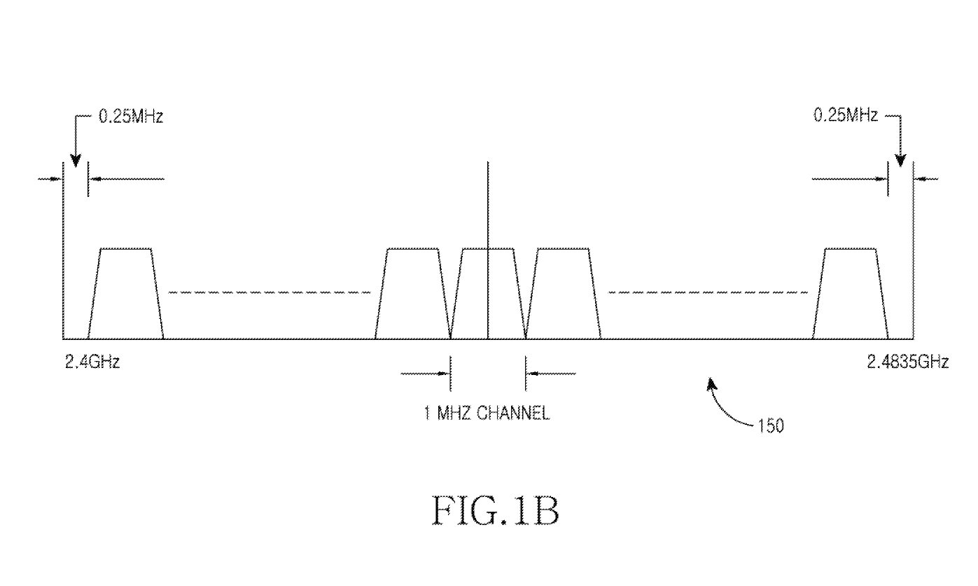

FIG. 1A is a block diagram of a wireless personal area network system 100 according to an embodiment of the present disclosure.

Referring to FIG. 1A, the Wireless Personal Area Network (WPAN) system 100 includes an Access Point (AP) 102 and low power devices 104A-N. The low power devices may include a wide range of sensors nodes. The low power devices 104A-N are connected to the AP 102 through a WPAN.

In an example, the WPAN system 100 may be an ultra-low power WPAN system. The WPAN system 100 is configured for operating within a range of 0-40 meters. The AP 102 is configured for communicating with the low power devices 104A-N over 1 MHz channels within 83.5 MHz bandwidth. The low power devices 104A-N are configured for sensing data and transmitting the sensed data to the AP 102 in 1 MHz channels allocated in the 83.5 MHz bandwidth. A band plan 150 for the WPAN system 100 is illustrated in FIG. 1B.

FIG. 1B is a schematic representation of a band plan for a WPAN system according to an embodiment of the present disclosure.

Referring to FIG. 1B, the entire 83.5 MHz bandwidth is divided into eighty three 1 MHz channels. The access point 102 and the low power devices 104A-N transmit and receive data signals over any one of the 1 MHz channels or multiple 1 MHz channels simultaneously with high power network devices such as Wi-Fi devices and Bluetooth class 1 devices.

The present disclosure provides a method and system for combating interference from high power network devices when the AP 102 and the low power devices 104A-N communicate over the 2.4 GHz band simultaneously with the high power network devices in the manner described below.

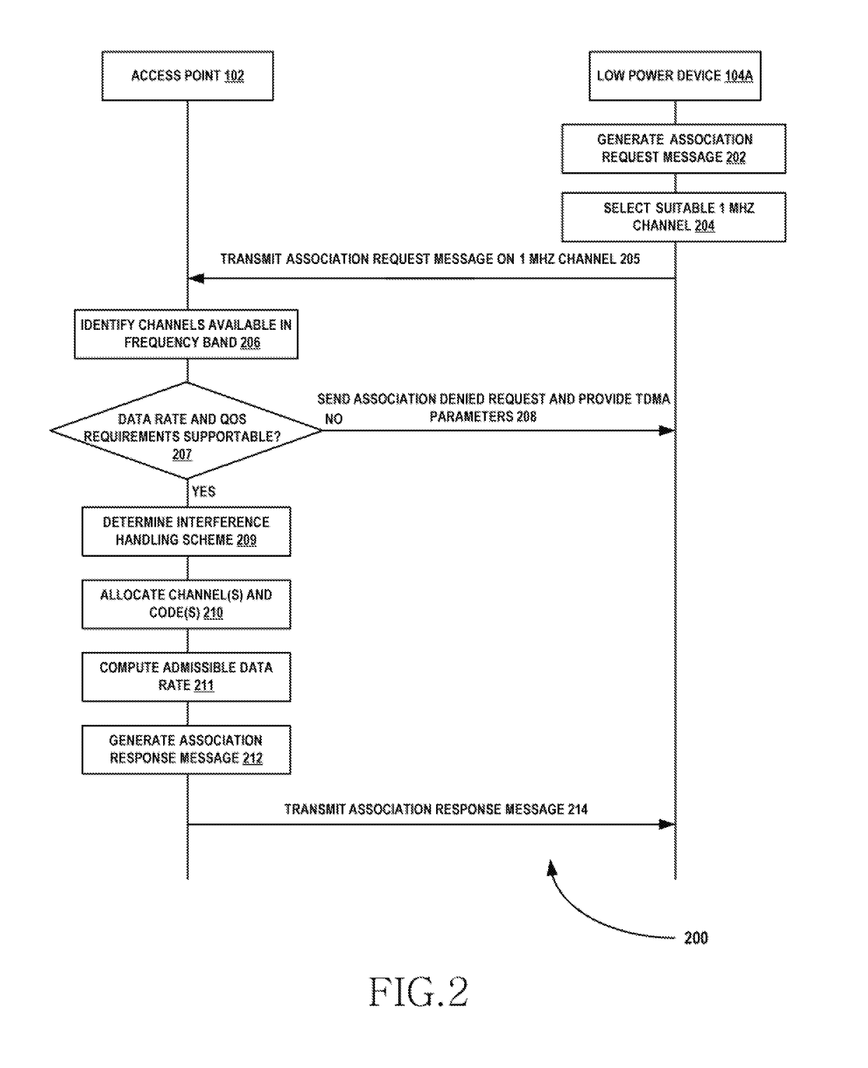

FIG. 2 is a flow diagram 200 illustrating a method of allocating resources to the low power devices 104A-N for data transmission in an uplink direction according to an embodiment of the present disclosure.

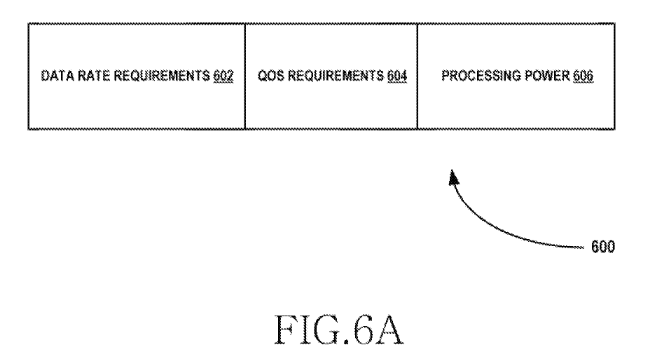

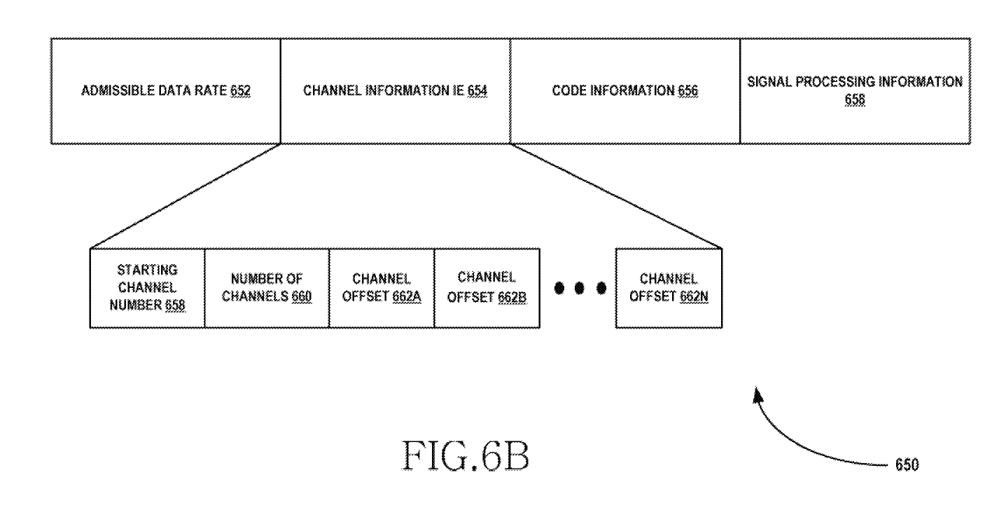

Referring to FIG. 2 in the case where a low power device 104A wishes to transmit data in an uplink direction, the low power device 104A requests the AP 102 for allocation of resources to transmit data in the uplink direction. At operation 202, the low power device 104A generates an association request message containing a first set of parameters associated with data to be transmitted in the uplink direction. For example, the first set of parameters includes data rate requirements (e.g., 10 Kbps to 1 Mbps), Quality of Service requirements (QoS) (e.g., low, high or medium) and processing power of the low power device 104A. An association request message carrying a set of parameters is illustrated in FIG. 6A, which is described further below.

At operation 204, the low power device 104A selects a suitable 1 MHz channel to transmit the association request message to the AP 102. In some various embodiments, the low power device 104A selects the suitable 1 MHz channel through channel sensing procedure. It can be noted that, selection of a channel based on a channel sensing procedure would increase the probability of successful reception of the association request message at the AP 102. At operation 205, the low power device 104A transmits the association request message to the AP 102 on the selected 1 MHz channel.

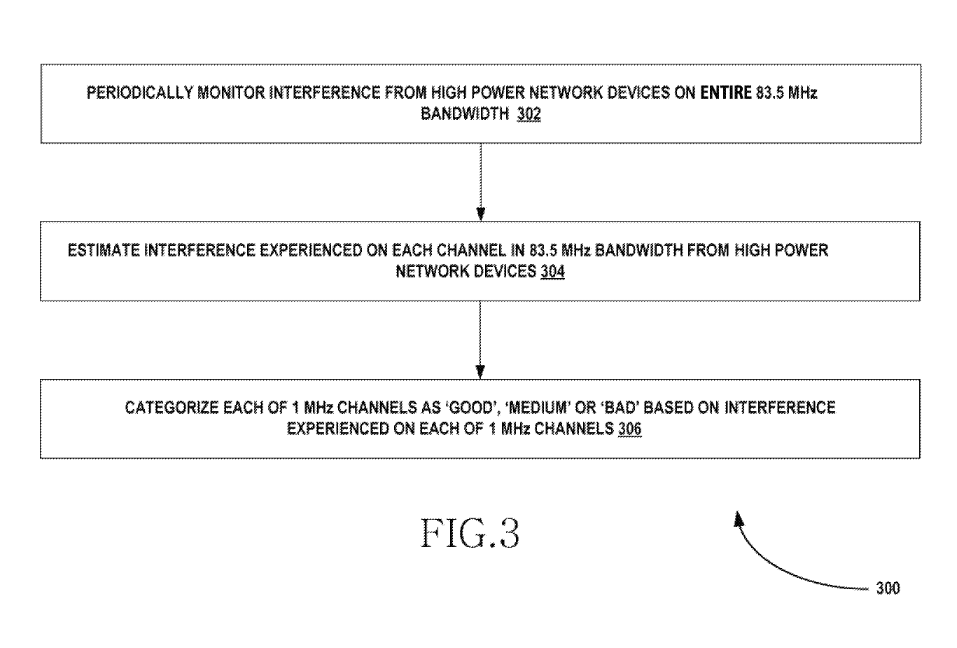

At operation 206, the AP 102 identifies a plurality of 1 MHz channels available in the frequency band based on a category of channels. In some various embodiments, the AP 102 maintains a list of channels which are categorized as ‘good’, ‘medium’ and ‘bad’ based on interference on a respective channel from the high power network devices on the entire 83.5 MHz bandwidth. In these various embodiments, the AP 102 selects channels having a minimum interference level that are categorized as “good” and/or “medium”. The process of categorizing the channels in the entire 83.5 MHz bandwidth is illustrated in greater detail in FIG. 3, which is described further below.

At operation 207, the AP 102 determines whether the data rate requirements and the QoS requirements are supportable with respect to interference from the high power network devices based on the interference on the available channels. If, at operation 207, the AP 102 determines that the data rate requirements and the QoS requirements are not supportable, then at operation 208, the AP 102 sends an association denied message to the low power device 104A and provides a Time Division Multiple Access (TDMA) to obtain an interference free channel for data transmission.

If the data rate requirements and the QoS requirements are supportable, then at operation 209, the AP 102 determines an interference handling scheme appropriate for transmitting the data in the uplink direction on the available channels based on interference on the available channels from the high power network devices. According to the present disclosure, the AP 102 determines an appropriate interference handling scheme as a combination of signaling processing schemes including but not limited to a Processing Gain (PG) scheme, a Frequency Diversity (FD) scheme, a Code Diversity (CD) scheme, and an Interference Rejection Filtering (IRF) scheme. For determining the interference handling scheme, the AP 102 first measures received signal power (P_{RX}) based on the association request message received from the low power device 104A. The AP 102 calculates path loss from the measured received signal power. For example, the AP 102 calculates the path loss from the received signal power (P_{RX}) using the expression as given below:

P_{RX}=Transmitted Power−Path loss−Implementation loss

Thereafter, the AP 102 estimates distance of the low power device 104A from the AP 102 from the calculated path loss. In one implementation, the distance is estimated from the path loss based on following equation:

Path loss=40.2+20 log₁₀(estimated distance).

For example, the value of transmitted power would be 0 dBm and the implementation loss would be approximately 5 dB.

Upon measuring the received signal power, the AP 102 calculates effective received signal power from the received signal power. For example, the AP 102 calculates effective received signal power (P_{RX}_{_{—}}_{eff}) as follows:

P_{RX}_{_{—}}_{eff}=P_{RX}+(PG+IRF),

where PG and IRF are gains related to an orthogonal spreading code and an interference rejection filter, respectively, and are added to the received signal power at the AP 102.

Then, the AP 102 computes the difference between the effective received signal power and the interference measured on the available channels. Accordingly, the AP 102 determines an appropriate interference handling scheme based on various signal processing schemes.

In one embodiment, the AP 102 selects a combination of the IRF scheme and the PG scheme for handling interference during data transmission in an uplink direction when the interference measured on the available channels is less than or equal to a difference between the effective received signal power and a minimum power level required to detect a low power signal (3 dB). The minimum power level is a power level required for a detection of a low power signal at the AP 102.

In another embodiment, the AP 102 selects a combination of an FD scheme, a PG scheme and an IRF scheme for handling interference during data transmission in the uplink direction when the interference measured on the available channels is greater than or equal to the effective received signal power. In this embodiment, the AP 102 selects the order of the FD scheme based on the interference power that is above the effective received signal power. For example, the AP 102 selects the order of FD scheme as ‘2’ when the interference power is 3 dBm higher than the effective receive signal power. However, if the interference power is greater than the effective received signal power by 6 dBm, the AP 102 selects the order of FD scheme as ‘4’. It can be noted that the AP 102 selects the combination of the FD scheme, the PG scheme and the IRF scheme till the maximum order of the FD scheme is reached. In one implementation, the maximum order of the FD scheme which the AP 102 can select is 8. However, it can be noted that the maximum order of the FD scheme may be greater than or less than ‘8’ based on number of low power devices to be supported by the AP 102 at a given instance.

In yet another embodiment, when the maximum order of the FD scheme is reached, the AP 102 suggests a combination of the CD scheme along with the PG scheme, the IRF scheme and the FD scheme for handling interference on the allocated channels from the high power network devices.

For example, consider that the distance of the low power device 104A from the AP 102 is 10 m. Also, consider that the data rate requirement is 10 Kbps. The path loss is computed as 40.2+20 log 10 (estimated distance)=40.2+20 log 10 (10)=60.2 dB.

Now consider that, the transmit power is 0 dBm and the implementation loss is 5 dB. Then, the received signal power (P_{RX})=transmit power−path loss−implementation loss=0−60.2−5=−65.2 dBm

Further, consider that length of spreading code corresponding to the data rate is 64 and the gain achieved on the IRF scheme is 6 dB. Then, the PG is computed as 10 log 10 (length of spreading code)=10 log 10 (64)=18 dB. Further, an effective received power (P_{RX}_{_{—}}_{eff}) is computed as received signal power+(PG+IRF)=−65.2+24=−41.2 dBm.

If the measured interference power on the available channels is −44.2 dBm, then the AP 102 determines that the difference between the effective received signal power and measured interference power is equal to a minimum power level (i.e., 3 dBm). Hence, the AP 102 determines that the IRF scheme and the PG scheme are sufficient for handling interference on the available channels from the high power network devices.

It can be noted that, the AP 102 also considers different signal processing schemes supported by the low power device 104A prior to determining the interference handling scheme. For example, the AP 102 determines signal processing schemes from the processing power information in the association request message and determines the interference handling scheme based on the determined signal processing schemes.

At operation 210, the AP 102 allocates one or more channels from the available channels and one or more spreading codes from a code set to the low power device 104A suitable for transmission of data in the uplink direction based on the interference handling scheme. For instance, consider that the data rate requirements are high, and the QoS requirements are high and the processing power is high. In such a case, the AP 102 allocates 16 channels that are categorized as ‘good’ and/or ‘medium’ and 4 code sets (each having a same number of multiple codes) to handle interference of −38.2 dBm. In another instance, when the data rate requirements are low, the QoS requirement is high and the processing power is low, the AP 102 allocates a channel of a ‘good’ category and a maximum length code to the low power device 104A.

In an embodiment, if the PG and IRF are determined as the interference handling scheme, then the AP 102 allocates 1 ‘good’ channel and 1 maximum length code for data transmission. If the combination of PG, FD and IRF is selected as the interference handling scheme, then the AP 102 allocates multiple channels corresponding to the order of the selected FD and the single spreading code from the code set. If the combination of PG, FD, CD and IRF is selected as the interference handling scheme, then the AP 102 allocates multiple channels corresponding to the order of FD and multiple codes corresponding to the order of CD.

At operation 211, the AP 102 computes an admissible data rate for the transmission of data (e.g., 10 Kbps, 1 Mbps) based on the interference on the allocated channels and the data rate requirements indicated in the association request message. The admissible data rate indicates the maximum data rate for the low power device 104A during transmission in the uplink direction. For example, for a 125 Kbps data rate request, and if interference is >−35 dBm but <−26 dBm, the AP 102 can allow a maximum data rate of 62.5 Kbps on the allocated channels.

At operation 212, the AP 102 generates an association response message containing a second set of parameter such as the admissible data rate, channel information associated with the allocated channel(s), code information associated with the allocated code(s) and the signal processing information. An association message is illustrated in FIG. 6B. At operation 214, the AP 102 sends the association response message to the low power device 104A. In some various embodiments, the AP 102 transmits the association response message with the second set of parameters to the low power device 104A on the same channel through which the association request message was sent by the low power device 104A.

FIG. 3 is a process flowchart 300 illustrating a method of categorizing channels in 83.5 MHz bandwidth based on interference from high power network devices according to an embodiment of the present disclosure.

Referring to FIG. 3, at operation 302, interference from high power network devices (e.g., Wi-Fi devices and Bluetooth class 1 devices) on the entire 83.5 MHz bandwidth in the 2.4 GHz band is periodically monitored. At operation 304, interference experienced on each of 1 MHz channels in the 83.5 MHz bandwidth from the high power network devices is estimated. At operation 306, each of the 1 MHz channels is categorized as “good”, “medium”, or “bad” based on the interference level estimated for each channel. The AP 102 maintains a list of channels and associated category and periodically updates the category of each of the channels based the interference affecting the channels from the high power network devices.

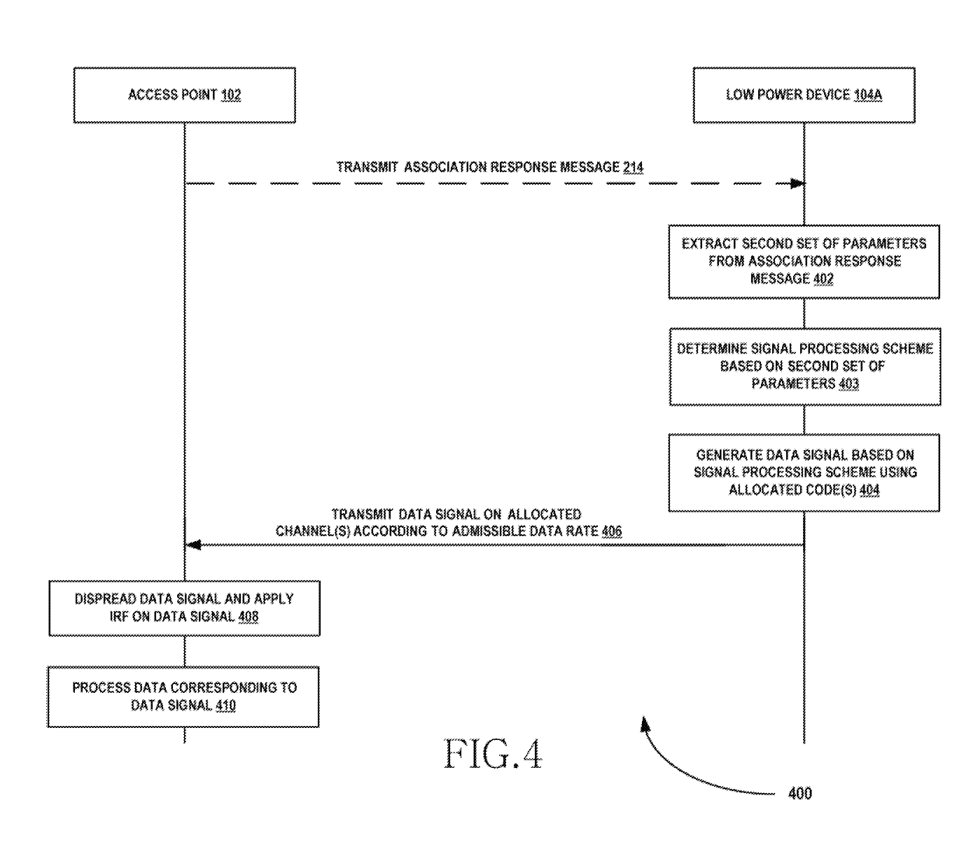

FIG. 4 is a flow diagram 400 illustrating a method of communicating data signal in uplink direction according to an embodiment of the present disclosure.

Referring to FIG. 4, upon receiving the association response message (which corresponds to operation 214 of FIG. 2), at operation 402, the low power device 104A extracts the second set of parameters such as an admissible date rate, channel information, code information, and signal processing information from the association response message. At operation 403, the low power device 104A determines signal processing scheme(s) to be applied in order to generate a data signal with a particular gain based on the second set of parameters (e.g., the channel information and the code information). For example, if the channel information indicates that a single channel is allocated and the code information indicates that a single spreading code is allocated, the low power device 104A determines that the signal processing schemes to be applied at the low power device 104A is PG. However, if the channel information indicates that multiple channels are allocated and the code information indicates that single spreading code is allocated, the low power device 104A determines that the signal processing scheme to be applied at the low power device 104A is PG and FD. Similarly, if the channel information indicates that multiple channels are allocated and the code information indicates that multiple spreading codes are allocated, the low power device 104A determines that the signal processing schemes to be applied at the low power device 104A are PG, FD and CD.

At operation 404, the low power device 104A generates a data signal by processing data to be transmitted in an uplink direction based on the signal processing scheme(s) using the allocated code(s). In other words, at operation 404, the low power device 104A applies the determined signal processing scheme(s) to boost gain (i.e., signal power level) associated with the data signal. It can be noted that, boosting the gain associated with the data signal would assist in combating the interference from the high power network devices.

The low power device 104A introduces a PG in the data signal by spreading the data signal in the allocated channel using the allocated spreading code. The amount of the PG added to the data signal increases with the length of the spreading code. For introducing the FD gain, the low power device 104A spreads the data signal in a 1 MHz channel using the allocated spreading code and repeats the spread data signal over multiple 1 MHz channels. The number of channels over which the spread data signal is repeated depends on the order of the FD gain scheme. The order of the FD gain scheme depends on an amount of interference experienced on the channels. That is, the higher the interference level, the higher the order of the FD gain scheme will be. Ideally, the AP 102 can detect a data signal having a signal power of 3 dB higher than the measured interference level. Thus, when the interference level is greater than an effective received signal power of consecutive data signals, an order of the FD gain scheme is increased based on the value of the interference level. At the receiver, i.e., AP 102, the wideband received signal is sub-sampled at the rate of 1 MHz. By this, the data signal spread within each 1 MHz channel gets aliased at the AP 102, resulting in adding up the spread signal over the multiple 1 MHz channels allocated to the low power device 104A. As a consequence, the frequency diversity gain is automatically achieved at the AP 102.

The CD gain scheme can be achieved using multiple orthogonal codes allocated from a code set to boost a signal power of the data signal. According to the CD gain scheme, the same data signal is spread using the allocated multiple orthogonal codes of same length. The maximum number of code sets assigned to the low power device 104A within a channel is 4.

At operation 406, the low power device 104A transmits the processed data signal to the AP 102 over the allocated channels according to the admissible data rate. At operation 408, the AP 102 dispreads the data signal using the spreading code and applies the IRF scheme on the received data signal to reject in-band interference. The application of the IRF scheme would improve SINR of the received data signal by 5 to 6 dB. At operation 410, the AP 102 processes the data corresponding to the data signal.

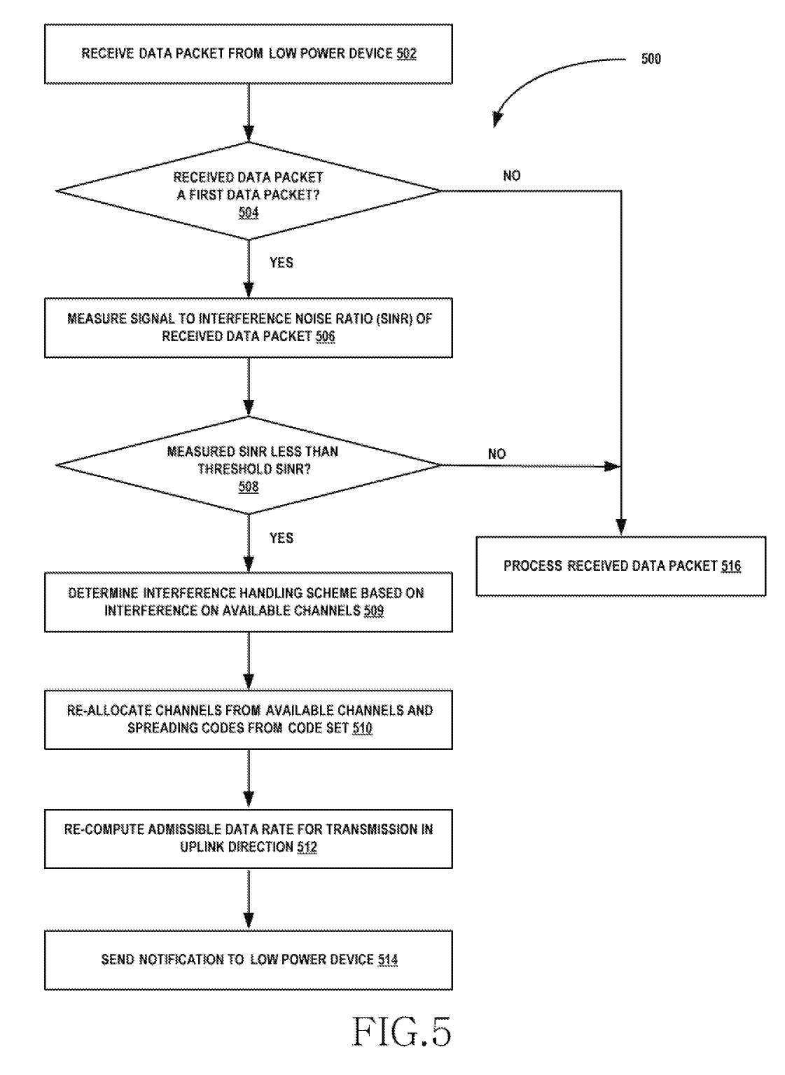

FIG. 5 is a process flowchart 500 illustrating a method of re-allocation of resources based on a Signal to Interference Noise Ratio (SINR) associated with a data packet received from the low power device 104A according to an embodiment of the disclosure.

Referring to FIG. 5, consider that, the AP 102 receives a data packet from the low power device 104A, at operation 502. At operation 504, it is determined whether the received data packet is a first data packet after transmission of the association response message. If the received data packet is a first data packet, then at operation 506, SINR associated with the received data packet is measured. The SINR associated with the received data packet indicates a strength of a signal relative to interference noise. The SINR is computed as follows:

SINR=Psignal/Pnoise

where Psignal is the average signal power and Pnoise is the average interference power. If the received data packet is not a first data packet, then at operation 516, the received data packet is directly processed.

At operation 508, it is determined whether the measured SINR is less than a threshold SINR. If the measured SINR is less than the threshold SINR, it implies that the interference level is too high and the data packet cannot be detected. In such case, at operation 509, the AP 102 determines an interference handling scheme appropriate for transmitting the data on the uplink direction based on interference from the high power network devices on the available channels. At operation 510, the spreading codes and the channels are re-allocated from the available channels based on the category. At operation 512, the admissible data rate is re-computed for data transmission based on the interference on the re-allocated channels. At operation 514, the AP 102 sends a notification indicating channel information associated with the re-allocated channels, code information associated with the re-allocated spreading codes, a re-computed maximum data rate and signal processing information to the low power device 104A. Consider that the measured SINR is equal to or greater than the threshold SINR, then the received data packet is processed at operation 516.

FIG. 6A is a schematic representation depicting a format of an association request message 600 according to an embodiment of the present disclosure.

Referring to FIG. 6A, the association request message 600 includes a data rate requirement field 602, a QoS requirement field 604, and a processing power field 606. The data rate requirement field 602 indicates a desired data rate for transmission of data in the uplink direction. For example, the data rate requirement field 602 is set to a value “000” if the data rate required for transmission of data in the uplink direction is 10 Kbps. However, if the data rate required for transmission of data in the uplink direction is 1 Mbps, then the data rate requirement field 602 is set to a value “011”. The below table 1 indicates one of various field values assigned to indicate a required data rate to the AP 102.

TABLE 1

| “Required Data Rate” field value | Data rate | |
|---|---|---|
| 000 | 10 | Kbps |
| 001 | 125 | Kbps |
| 010 | 500 | Kbps |
| 011 | 1 | Mbps |

| | |
|---|---|
| 100-111 | Reserved |

The QoS requirement field 604 indicates a type of QoS desired during transmission of data in the uplink direction. For example, the QoS requirement field 604 is set to a value ‘01’ if the QoS requirement associated with the data transmission is low. On the other hand, if the QoS requirement associated with the data transmission is high, the QoS requirement field 604 is set to a value ‘11’. Table 2 shows different QoS requirement values set to indicate a QoS requirement for data transmission in an uplink direction.

TABLE 2

| “QoS” field value | QoS Requirement |
|---|---|
| 00 | Reserved |
| 01 | Low |
| 10 | Medium |
| 11 | High |

The processing power field 606 indicates a processing capability of the low power device 104A. For example, the processing power field 606 is set to a value ‘01’ if the processing power is ‘FD’. If the processing power associated with the data transmission is both FD and CD, the processing power field 606 is set to a value ‘11’. Table 3 shows different field values set to indicate a processing power associated with the low power device 104A.

TABLE 3

| “Processing Power” field value | Processing Power |
|---|---|
| 00 | No FD and CD |
| 01 | FD |
| 10 | CD |
| 11 | Both FD and CD |

FIG. 6B is a schematic representation depicting a format of an association response message 650 according to an embodiment of the present disclosure.

Referring to FIG. 6B, the association response message 650 includes an admissible data rate field 652, a channel information Information Element (IE) 654, a code information field 656, and a signal processing information field 658. The admissible data rate field 652 indicates a maximum data rate during data transmission in an uplink direction. For example, the admissible data rate field 652 is set to a value ‘000’ when the maximum data rate is equal to 10 Kbps. On the other hand, when the maximum data rate is equal to 1 Mbps, the admissible data rate field 652 is set to a value ‘011’. The below Table 4 shows different field values that indicates different admissible data rates.

TABLE 4

| Field value | Admission Data Rate | |
|---|---|---|
| 000 | 10 | Kbps |
| 001 | 125 | Kbps |
| 010 | 500 | Kbps |
| 011 | 1 | Mbps |

| | |
|---|---|
| 100-111 | Reserved |

The channel information IE 654 indicates channel information associated with the allocated channels for transmission of data in uplink direction. The channel information IE 654 is a variable field IE and is carried in a payload of the association response message 650. As depicted, the channel information IE 654 includes a starting channel number field 658, a number of channels field 660, and channel offset fields 662A-N. The starting channel number field 658 indicates index of a first channel assigned to the low power device 104A. The size of the first channel field 658 is 1 byte. The number of channels field 660 indicates number of channels allocated to the low power device 104A to transmit data in uplink direction. The size of the number of channel field 660 is 4 bits. Each of the channel offset fields 662A-N indicates offset of a current allocated channel with respect to a previous allocated channel. For example, the channel offset field 662A indicates offset of the second channel from the first channel in the 2.4 GHz band. On the other hand, the channel offset field 662N indicates offset of nth channel from the (n−1)th channel. It can be noted that, total of sixteen channels can be allocated to a low power device. Therefore, a maximum offset equal to sixteen is allowed from one channel to another channel. The size of the channel offset 662 field is 4 bits.

The code information field 656 indicates row numbers associated with a code look up table. The row numbers refer to codes in the code look up table. The signal processing information field 658 indicates which of the allocated codes to be used for increasing a data rate and for CD.

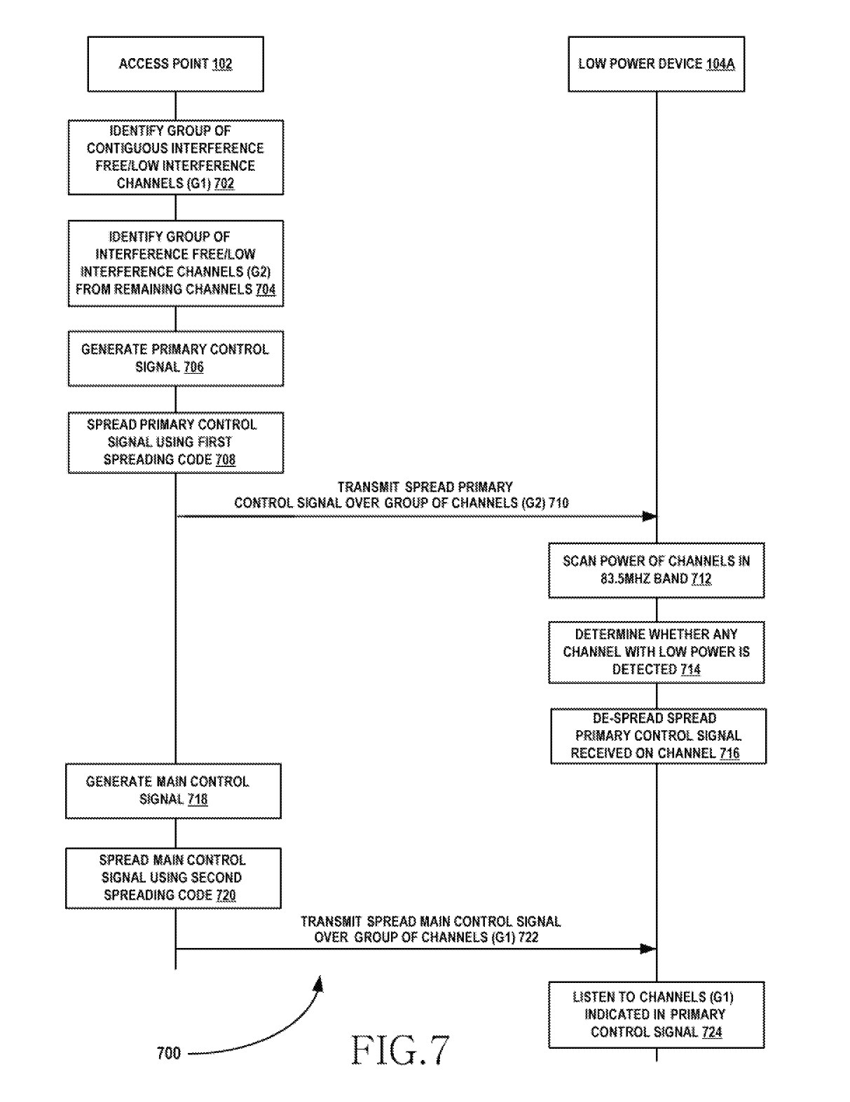

FIG. 7 is a flow diagram 700 illustrating a method of communicating control signals with low power devices in a downlink direction according to an embodiment of the present disclosure.

Referring to FIG. 7, consider that the AP 102 wishes to transmit a control signal to the sensor 104A. In such a case, the AP 102 transmits a primary control signal followed by a main control signal as described below.

At operation 702, the AP 102 identifies a group of contiguous interference free/low interference channels (G 1) from 1 MHz channels spread over the 83.5 MHz bandwidth for transmission of a main control signal based on a pre-defined category of channels. In some various embodiments, the AP 102 monitors interference on each channel from high power network devices (e.g., Wi-Fi devices). In these various embodiments, the AP 102 categorizes each of the channels based on an interference level experienced on each channel. For example, if the interference level is low, the channel is categorized as good. If the interference level is high, the channel is categorized as bad. In these various embodiments, the AP 102 maintains a list of channels and an associated category based on the interference level on each channel. Accordingly, the AP 102 identifies a set of contiguous channels which are either categorized as good or medium using the list of channels and associated category information. It can be noted that, the contiguous channels identified for transmission of the main control signal may range from one to sixteen. Also, the set of contiguous channels may include two groups of contiguous channels in close vicinity to each other over the 83.5 MHz bandwidth.

At operation 704, the AP 102 identifies a group of contiguous/non-contiguous interference free/low interference channels (G2) from the remaining 1 MHz channels for transmitting the primary control signal. In some various embodiments, the AP 102 identifies the group of channels (G2) from the remaining 1 MHz channels based on the pre-defined category of channels. For example, the AP 102 selects channels (G2) which are categorized as ‘good’ or ‘medium’ and are not included in the group of contiguous channels (G1) identified in operation 702.

At operation 706, the AP 102 generates a primary control signal indicating channel information associated with the main control signal. For example, the channel information associated with the main control signal includes a channel location, a number of contiguous channels (G1) over which the main control signal is to be transmitted, and so on. At operation 708, the AP 102 spreads the primary control signal over 1 MHz by using a first pre-defined spreading code. In one implementation, the AP 102 spreads the primary control signal using a long length spreading code (e.g., Walsh Hadamard Code of a length of 128 bits). Spreading of the control signal using the long length spreading code helps significantly increase the signal power over the interference at the low power device 104A. At operation 710, the AP 102 transmits the spread primary control signal to the low power device 104A on the channels (G2) identified in operation 704.

At operation 712, the low power device 104A scans the power of the channels over the 83.5 MHz bandwidth after wake up from a sleep mode. At operation 714, the low power device 104A determines whether any channel having a power level less than or equal to a minimum transmit power is detected. If the channel with low power is detected, then at operation 716, the low power device 104A de-spreads the spread primary control signal using the first pre-defined spreading code to obtain the channel information associated with the main control signal.

At operation 718, the AP 102 generates the main control signal containing control data. At operation 720, the AP 102 spreads the main control signal using a second pre-defined spreading code. In one implementation, the AP 102 spreads the main control signal using a long length spreading code (e.g., Walsh Hadamard Code of a length of 128 bits). Spreading of the control signal using the long length spreading code helps significantly increase the signal power over the interference at the low power device 104A. At operation 722, the AP 102 transmits the spread main control signal to the low power device 104A. In some various embodiments, the AP 102 repeats the spread main control signal over the group of contiguous channels (G1) to further increase the signal power over interference at the low power device 104A. In these various embodiments, the AP 102 uses a variable order frequency diversity scheme to achieve a very high gain in the received signal power. For example, if the channel is good and a distance between the AP 102 and the low power device 104A is less, then the AP 102 uses the FD scheme of an order of ‘2’. However, if the distance increases and/or interference level on the channel increases, the AP 102 increases an order of the FD scheme by a value of ‘2’ for every 3 dB loss of signal power due to an increase in the distance or 3 dB increase in the interference power in medium categorized channels. It can be noted that, the AP 102 can transmit the spread main control signal over a single channel if the AP 102 finds a single interference free channel for transmitting the main control signal.

Based on the channel information, at operation 724, the low power device 104A listens to the channels indicated in the primary control signal. Accordingly, the low power device 104A de-spreads the spread main control signal to obtain control data upon receiving the spread main control signal from the AP 102 in any of the contiguous channels indicated in the channel information in the primary control signal.

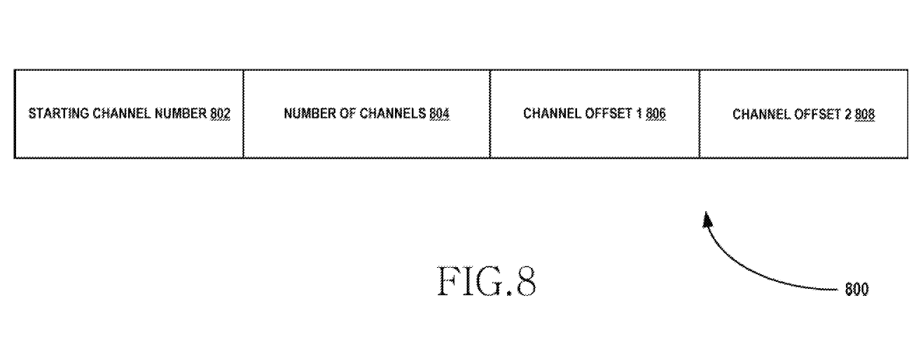

FIG. 8 is a schematic representation depicting a format of a primary control signal 800 according to an embodiment of the present disclosure.

Referring to FIG. 8, the primary control signal 800 includes a starting channel number field 802, a number of channels field 804, a channel offset 1 field 806, and a channel offset 2 field 808. The starting channel number field 802 indicates an index of a first channel in the set of contiguous channels identified for transmitting the main control signal. The size of the starting channel number field 802 is 1 byte. The number of channels field 804 indicates a number of channels to be used to transmit the main control signal. The size of the number of channels field 804 is 4 bits.

The channel offset 1 field 806 indicates an offset of a first group of channels from the first channel. The size of the channel offset 1 field 806 is 4 bits. The channel offset 2 field 808 indicates an offset of a second group of channels from the first channel. The size of the channel offset 2 field 808 is 4 bits. The channel offset 1 field 806 and the channel offset 2 field 808 are used when the contiguous channel contains contiguous channel groups in close vicinity to each other.

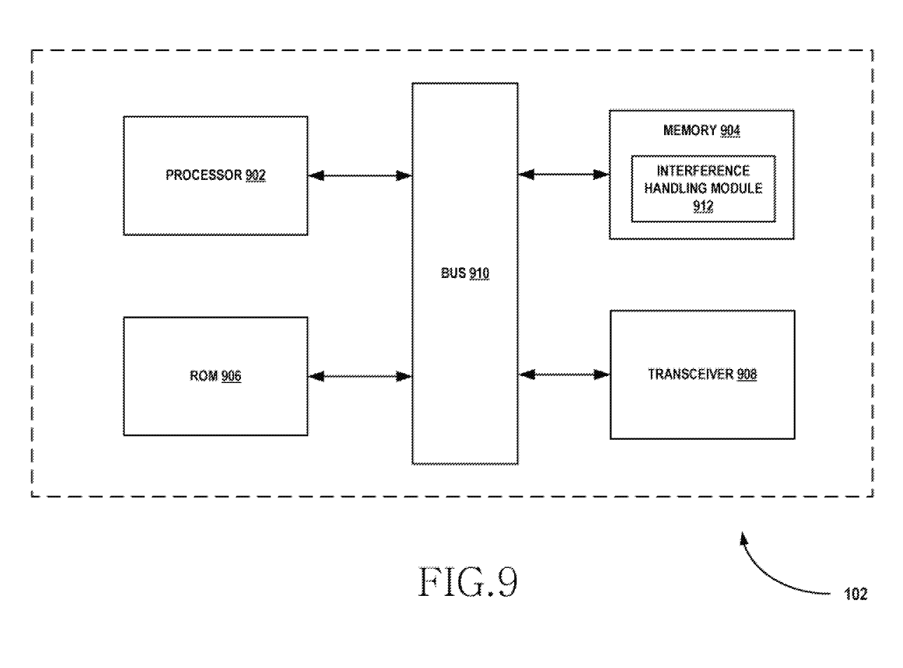

FIG. 9 is a block diagram of the access point 102 showing various components for implementing embodiments of the present subject matter according to an embodiment of the present disclosure. Referring to FIG. 9, the access point 102 includes a processor 902, a memory 904, a Read Only Memory (ROM) 906, a transceiver 908, and a bus 910.

The processor 902, as used herein, denotes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 902 may also include embedded controllers, such as generic or programmable logic devices or arrays, application specific integrated circuits, single-chip computers, smart cards, and the like.

The memory 904 and the ROM 906 may be volatile memory and non-volatile memory. The memory 904 includes an interference handling module 912 for allocating resources to the low power devices 104A-N, transmitting control signals in a downlink direction, and processing data received in an uplink direction such that interference from high power network devices on a common frequency band is managed, according to one or more embodiments described in FIGS. 2-8. A variety of non-transitory computer-readable storage media may be stored in and accessed from the memory elements. Memory elements may include any suitable memory device(s) for storing data and machine-readable instructions, such as a read only memory, a random access memory, an erasable programmable read only memory, an electrically erasable programmable read only memory, a hard drive, a removable media drive for handling compact disks, a digital video disk, a diskette, a magnetic tape cartridge, a memory card, and the like.

Various embodiments of the present disclosure may be implemented in conjunction with modules, including functions, procedures, data structures, and application programs, for performing tasks, or defining abstract data types or low-level hardware contexts. The interference handling module 912 may be stored in the form of machine-readable instructions on any of the above-mentioned non-transitory storage media and may be executable by the processor 902. For example, a computer program may include machine-readable instructions capable of allocating resources to the low power devices 104A-N, transmitting control signals in a downlink direction, and processing data received in an uplink direction such that interference from high power network devices on a common frequency band is managed, according to the teachings and herein described various embodiments illustrated in FIGS. 2-8. In one embodiment, the program may be included on a Compact Disk-Read Only Memory (CD-ROM) and loaded from the CD-ROM to a hard drive in the non-volatile memory.

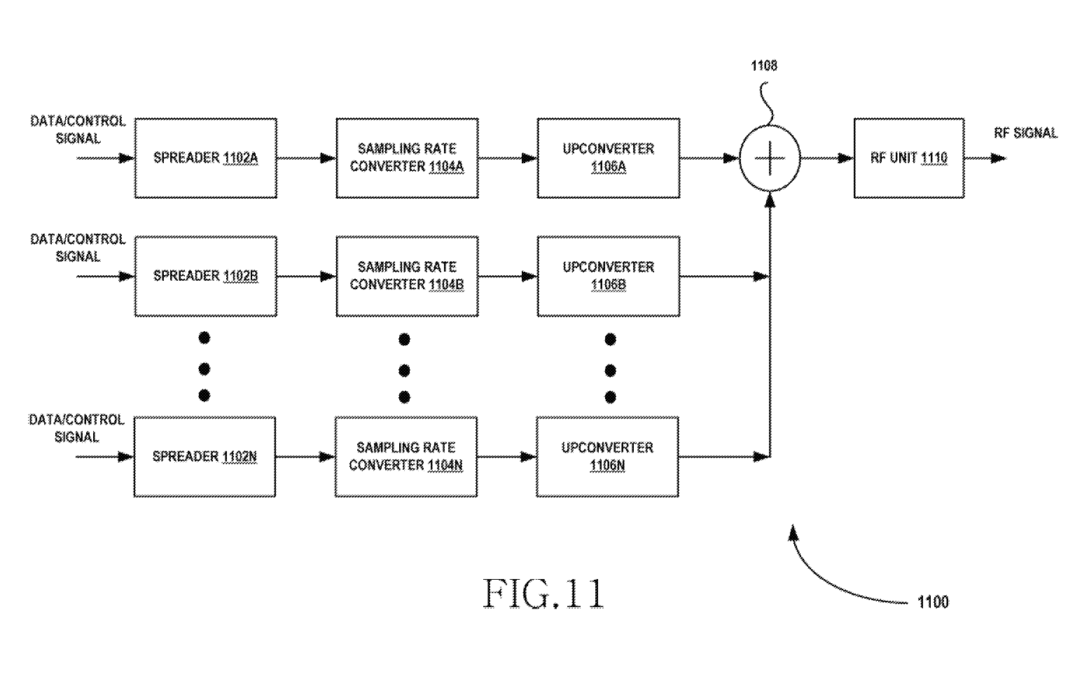

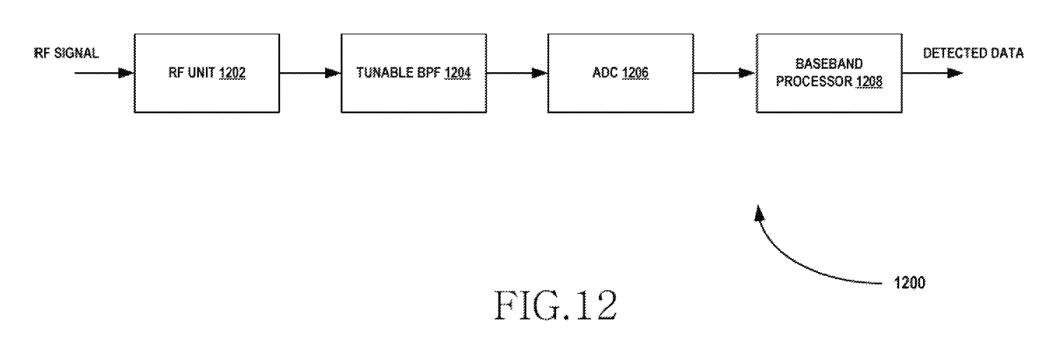

The transceiver 908 may be capable of receiving an association request message including a first set of parameters, transmitting an association response message including a second set of parameters, receiving and processing data in an uplink direction, processing and transmitting a control signal in a downlink direction. For example, a receiver side architecture and a transmitter side architecture of the transceiver 908 is illustrated in FIGS. 11 and 12. The bus 910 acts as an interconnect between various components of the access point 102.

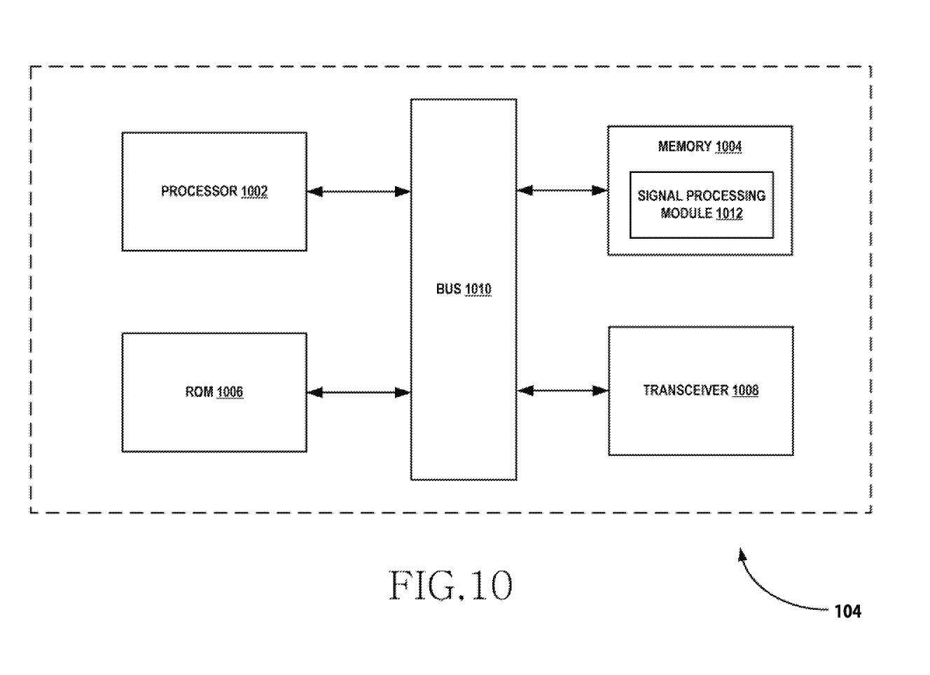

FIG. 10 is a block diagram of the low power device 104 showing various components for implementing embodiments of the present disclosure. Referring to FIG. 10, the low power device 104 includes a processor 1002, a memory 1004, a ROM 1006, a transceiver 1008, and a bus 1010.

The processor 1002, as used herein, denotes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 1002 may also include embedded controllers, such as generic or programmable logic devices or arrays, application specific integrated circuits, single-chip computers, smart cards, and the like.

The memory 1004 and the ROM 1006 may be volatile memory and non-volatile memory. The memory 1004 includes a signal processing module 1012 for receiving and processing control signals in a downlink direction, and processing and transmitting data in an uplink direction such that interference from high power network devices on a common frequency band is managed, according to one or more embodiments described in FIGS. 2-8. A variety of non-transitory computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drives, removable media drives for handling compact disks, digital video disks, diskettes, magnetic tape cartridges, memory cards, and the like.

Various embodiments of the present disclosure may be implemented in conjunction with modules, including functions, procedures, data structures, and application programs, for performing tasks, or defining abstract data types or low-level hardware contexts. The signal processing module 1012 may be stored in the form of machine-readable instructions on any of the above-mentioned non-transitory storage media and may be executable by the processor 1002. For example, a computer program may include machine-readable instructions capable of receiving and processing control signals in a downlink direction, and processing and transmitting data in an uplink direction such that interference from high power network devices on a common frequency band is managed, according to the teachings and herein described various embodiments illustrated in FIGS. 2-8. In one embodiment, the program may be included on a CD-ROM and loaded from the CD-ROM to a hard drive in the non-volatile memory.

The transceiver 1008 may be capable of transmitting an association request message including a first set of parameters, receiving an association response message including a second set of parameters, transmitting data in uplink direction, receiving control signal in downlink direction. For example, a receiver side architecture and a transmitter side architecture of the transceiver 1008 is illustrated in FIGS. 11 and 12. The bus 1010 acts as an interconnect between various components of the low power device 104.

FIG. 11 illustrates a block diagram of a transmitter 1100 according to an embodiment of the present disclosure.

The transmitter 1100 includes spreaders 1102A-N, sampling rate converters 1104A-N, up converters 1106A-N, an adder 1108, and a Radio Frequency (RF) unit 1110. In one embodiment, the transmitter architecture 1100 may be implemented at the AP 102. In an alternate embodiment, the transmitter architecture 1100 may be implemented at the low power device 104. It is appreciated that the transmitter 1100 is an embodiment of the transceiver 908 and the transceiver 1008 of FIG. 9 and FIG. 10, respectively.

The spreaders 1102A-N are configured for spreading a data signal on respective channels using a pre-defined spreading code to obtain a spread data signal. The sampling rate converters 1104A-N are configured for sampling the spread data signals at a predefined sampling rate. The up converters 1106A-N are configured for converting the spread data signals to radio frequency signals.

The adder 1108 is configured for adding the radio frequency signals corresponding to different channels to obtain a composite RF signal. The RF unit 1110 is configured for converting the digital RF signal to an analog RF signal and shaping a pulse of the analog signal. The RF unit 1110 is also configured for processing the analog RF signal based on signal processing schemes (e.g., PG and FD or PG and CD) to combat interference on the one or more channels of a frequency band from high power network devices, and transmitting the processed analog RF signal on the one or more channels.

FIG. 12 illustrates a block diagram of a receiver 1200 according to an embodiment of the present disclosure.

The receiver 1200 includes a RF unit 1202, a tunable band pass filter 1204, an Analog to Digital Converter (ADC) 1206, and a baseband processor 1208. In one embodiment, the receiver architecture 1200 may be implemented at the AP 102. In an alternate embodiment, the receiver architecture 1200 may be implemented at the low power device 104. It is appreciated that the receiver 1200 is an embodiment of the transceiver 908 and the transceiver 1008 of FIG. 9 and FIG. 10, respectively.

The RF unit 1202 is configured for processing an RF signal received from the transmitter 1100 on one or more channels over the 83.5 MHz bandwidth. The tunable band pass filter 1204 is configured for filtering the processed radio frequency signal. The ADC 1206 is configured for converting the analog RF signal into a digital signal. In some various embodiments, the ADC 1206 is also configured for sampling the analog RF signal at a sampling rate of 1 MHz. The baseband processor 1208 is configured for processing the digital signal to detect data corresponding to an original signal.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of handling interference between a low power network device and a high power network device during communication on a common frequency band, the method comprising:
receiving an association request message from the low power network device, wherein the association request message comprises a first set of parameters associated with data to be transmitted in an uplink direction;
determining, by an access point, a second set of parameters for transmission of the data in the uplink direction based on the first set of parameters, wherein the second set of parameters indicates resources allocated to the low power device for transmitting the data on a common frequency band in a presence of interference from the high power network device on the common frequency band; and
sending an association response message containing the second set of parameters to the low power device in response to the association request message.

2. The method of claim 1, wherein the determining of the second set of parameters for the transmission of the data in the uplink direction comprises:
identifying a plurality of channels within the frequency band available for the transmission of the data in the uplink direction based on a category of each channel in the frequency band;
determining an interference handling scheme based on the interference from the high power network device on available channels, and an effective received signal power;
allocating one or more channels from the available channels and one or more spreading codes from a code set to the low power device for transmitting the data on the frequency band based on the interference handling scheme; and
computing a maximum data rate for the transmission of the data on the allocated channels based on the interference on the allocated one or more channels.

3. The method of claim 2, wherein the second set of parameters comprises the admissible data rate, channel information associated with the allocated channels, code information associated with the allocated codes and signal processing information.

4. The method of claim 3, wherein the determining of the interference handling scheme based on the interference from the high power network device on the frequency band and the effective received signal power comprises:
measuring received signal power from the association request message received from the low power device;
calculating the effective received signal power using the received signal power;
computing a difference between the effective received signal power and the interference on the available channels; and
selecting the interference handling scheme appropriate for transmitting the data on the available channels based on the computed difference.

5. The method of claim 2, wherein the identifying of the plurality of channels within the frequency band available for the transmission of the data in the uplink direction based on the category of each channel in the frequency band comprises:
periodically monitoring interference from the high power network device on the frequency band;
estimating interference on each channel in the frequency band based on the interference measured on a 83.5 MHz bandwidth;
categorizing each channel into a pre-defined category based on the respective interference estimated on the said each channel; and
identifying one or more channels within the frequency band available for the transmission of the data in the uplink direction based on a category of each channel in the frequency band.

6. The method of claim 1, further comprising:
determining whether a data packet received from the low power device is a first data packet following the association response message;
measuring a Signal to Interference Noise Ratio (SINR) value from the received data packet if the data packet received from the low power device is the first data packet;
determining whether the measured SINR is less than a threshold SINR;
determining an interference handling scheme appropriate for transmitting the data on in the uplink direction based on interference from the high power network device on available channels;
re-allocating one or more channels from the available channels and spreading codes from a code set if the measured SINR is less than the threshold SINR; and
re-computing a maximum data rate for the transmission of the data on the reallocated channels based on the interference on the re-allocated channels; and
sending a notification indicating channel information associated with the re-allocated channels, the spreading codes the re-computed maximum data rate, and signaling processing information to the low power device.

7. An apparatus for handling interference between a low power network device and a high power network device during communication on a common frequency band, the apparatus comprising:
a transceiver; and
a processor coupled to the transceiver, wherein the transceiver is configured to receive an association request message comprising a first set of parameters associated with data to be transmitted in uplink direction from the low power network device, and wherein the processor is configured to determine a second set of parameters for transmission of the data in the uplink direction based on the first set of parameters, where the second set of parameters indicates resources allocated to the low power device for transmitting the data on a common frequency band in presence of interference from the high power network device on the common frequency band, and wherein the transceiver is configured to send an association response message containing the second set of parameters to the low power device in response to the association request message.

8. The apparatus of claim 7, wherein in determining the second set of parameters for the transmission of the data in the uplink direction, the processor is configured to:
identify a plurality of channels within the frequency band available for the transmission of the data in the uplink direction based on a category of each channel in the frequency band;
determine an interference handling scheme based on the interference from the high power network device on available channels, and an effective received signal power;
allocate one or more channels from the available channels and one or more spreading codes from a code set to the low power device for transmitting the data on the frequency band based on the interference handling scheme; and
compute a maximum data rate for transmission of the data on the allocated channels based on the interference on the allocated one or more channels.

9. The apparatus of claim 8, wherein the second set of parameters comprises the admissible data rate, channel information associated with the allocated channels, code information associated with the allocated codes and signal processing information.

10. The apparatus of claim 9, wherein in determining the interference handling scheme based on the interference from the high power network device on the frequency band and the effective received signal power associated with the low power device, the processor is configured to:
measure received signal power from the association request message received from the low power device;
calculate the effective received signal power using the received signal power;
compute a difference between the effective received signal power and the interference on the available channels; and
select the interference handling scheme appropriate for transmitting the data on the available channels based on a computed difference.

11. The apparatus of claim 8, wherein in identifying the plurality of channels within the frequency band available for the transmission of the data in the uplink direction based on the category of each channel in the frequency band, the processor is configured to:
periodically monitor interference from the high power network device on the frequency band;
estimate interference on each channel in the frequency band based on the interference measured on a 83.5 MHz bandwidth;
categorize each channel into a pre-defined category based on respective interference estimated on the said each channel; and
identify one or more channels within the frequency band available for the transmission of the data in the uplink direction based on a category of each channel in the frequency band.

12. The apparatus of claim 7, wherein the processor is configured to:
determine whether a data packet received from the low power device is a first data packet following the association response message;
measure Signal to Interference Noise Ratio (SINR) value from the received data packet if the data packet received from the low power device is the first data packet;
determine whether the measured SINR is less than a threshold SINR;
determine an interference handling scheme appropriate for transmitting the data in the uplink direction based on interference from the high power network device on available channels;
re-allocate one or more channels from the available channels and spreading codes from a code set if the measured SINR is less than the threshold SINR;
re-compute a maximum data rate for transmission of the data on the reallocated channels based on the interference on the re-allocated channels; and
send a notification indicating channel information associated with the re-allocated channels, the spreading codes the re-computed maximum data rate, and signaling processing information to the low power device.

13. A method of communicating control signals with low power device in a downlink direction, the method comprising:
identifying a first group of contiguous at least one of interference free and low interference channels from a plurality of channels in a frequency band based on a pre-defined category of the plurality of channels;
identifying a second group of at least one of interference free and low interference channels from a remaining of the plurality of channels based on the pre-defined category of the remaining channels;
transmitting a primary control signal on the second group of the at least one of interference free and low interference channels, wherein the primary control signal indicates channel information associated with the first group of the contiguous at least one of the interference free and low interference channels; and
transmitting a main control signal following the primary control signal on the group of the contiguous at least one of the interference free and low interference channels, wherein the main control signal comprises control data.

14. The method of claim 13, further comprising:
periodically monitoring an interference level on the frequency band caused by a high power network device;
estimating interference on each of the plurality of channels within the frequency band based on the interference level on the frequency band; and
categorizing each of the plurality of channels based on respective interference estimated on the said each channel into the pre-defined category.

15. An apparatus for communicating control signals with low power device in a downlink direction, the apparatus comprising:
a transceiver; and
a processor coupled to the transceiver, wherein the processor is configured to identifying a first group of contiguous at least one of interference free and low interference channels from a plurality of channels in a frequency band based on a pre-defined category of the plurality of channels, and wherein the processor is configured to identifying a second group of at least one of interference free and low interference channels from a remaining of the plurality of channels based on the pre-defined category of the remaining channels, and wherein the transceiver is configured to transmit a primary control signal on the second group of the at last one of interference free and low interference channels, where the primary control signal indicates channel information associated with the first group of the contiguous at least one of the interference free and low interference channels, and wherein the transceiver is configured to transmit a main control signal following the primary control signal on the first group of the contiguous at least one of the interference free and low interference channels, where the main control signal comprises control data.

16. A method of handling interference between a low power network and a high power network, the method comprising:
sending an association request message to an access point;
receiving an association response message from the access point in response to the association request message, wherein the association response message comprises an admissible data rate, channel information of allocated channels, code information of allocated codes, and a signal processing information;
generating a data signal based on the channel information and the code information; and
transmitting the data signal to the access point on the allocated channels according to the admissible data rate.

17. An apparatus for handling interference between a low power network and a high power network, the apparatus comprising:
a transceiver; and
a processor coupled to the transceiver, wherein the transceiver is configured to send an association request message to an access point, wherein the transceiver is configured to receive an association response message from the access point in response to the association request message, where the association response message comprises an admissible data rate, channel information of allocated channels, code information of allocated codes, and a signal processing information, and wherein the processor is configured to generate a data signal based on the channel information and the code information, and wherein the transceiver is configured to transmit the data signal to the access point on the allocated channels according to the admissible data rate.

18. A transmitter comprising:
a spreader configured to spread data on each of one or more channels using a unique spreading code to obtain a spread data signal;
a sampling rate converter configured for sampling the spread data signal at a sampling rate;
an up converter configured to convert the spread data signal to a radio frequency signal; and
a Radio Frequency (RF) unit configured to:
process the RF signal based on at least one signal processing scheme to mitigate interference on the one or more channels of a frequency band from high power network device; and
transmit the processed RF signal on the one or more channels.

19. A receiver comprising:
a Radio Frequency (RF) unit configured to process a RF signal received from a transmitter on one or more channels of a frequency band;
a band pass filter configured to filter the processed RF signal;
an analog to digital converter configured to convert the analog RF signal into a digital signal; and
a baseband processor configured to process the digital signal to detect data corresponding to an original signal.

20. A system comprising:
at least one low power device configured to send an association request message, wherein the association request message comprises a first set of parameters associated with data to be transmitted in uplink direction; and
an access point configured to:
determine a second set of parameters for transmission of the data in the uplink direction based on the first set of parameters, wherein the second set of parameters indicates resources allocated to the low power device for transmitting the data on a common frequency band in presence of interference from high power network device on the common frequency band; and
send an association response message containing the second set of parameters to the low power device in response to the association request message.
